(19) United States
(12) Patent Application Publication
(10) Pub. No.: US 2018/0356276 A1
(43) Pub. Date: Dec. 13, 2018

(54) AN IMPROVED CONVEYOR WEIGH CELL MODULE

(71) Applicant: D & G Mechanical Solutions Limited, Suffolk (GB)

(72) Inventor: David Bowie, Suffolk (GB)

(21) Appl. No.: 15/780,608

(22) PCT Filed: Dec. 1, 2016
(86) PCT No.: PCT/GB2016/053784

§ 371 Date: May 31, 2018

(30) Foreign Application Priority Data
Dec. 1, 2015 (GB) 1521182.4

(51) Int. Cl. G01G 11/04; G01G 11/00

(52) U.S. Cl. CPC G01G 11/04; G01G 11/003

(57) ABSTRACT

A weigh module (10) for a belt conveyor apparatus is disclosed. Said module (10) comprises a support means, in the form of a plurality of shafts (30) to support a conveyor belt. The module also includes a means to measure rotation of the shaft, which means is preferably a rotary encoder. The shafts are support on elongate supports. In order to determine the mass of material on a conveyor belt, the module includes a load cell engaging a load plate to determine the load on a belt. The shafts are generally cylindrical and can have a plurality of spaced apart rings along the outer surface to engage a conveyor belt.

### FIELD OF THE INVENTION

The present invention relates to a conveyor belt apparatus and a weigh module associated therewith. In particular the invention concerns a module which is more serviceable, durable and also enables more accurate readings of the mass on the conveyor belt to be made.

### BACKGROUND TO THE INVENTION

Conveyor belt systems to move large volumes of solid materials between locations are well known in the art and provide one of the most cost-effective means for said transport when two locations are not a large distance apart. Such systems find particular use in industries such as mining or quarrying where a large mass of stone, soil, rubble etc. needs to be moved.

As will be expected therefore, the conditions under which the conveyor systems operate can be challenging as the material can be hard, have sharp edges and often be harmful to operators or machinery. Moreover, a large amount of dust is often associated with materials which dust can damage apparatus for making up the system, particularly bearings and other surfaces which moveably engage each other.

One aspect which is especially problematic is that used to determine mass flow along the conveyor belt. Advantageously, for reasons of efficiency, continuous measurement is carried out rather than batch measurement, even though on the whole continuous measurements are less accurate. One general methodology employed to enable continuous measurement is to carry out a determination of the mass of the belt and material at different points in time. This involves the knowledge of the speed of the belt and the mass of the belt plus material, which information can then be processed with the required information. Given the harsh conditions indicated above, both measurements can be problematic leading to weigh modules needing to be replaced at regular and frequent intervals.

Continuous weighing systems need to measure the conveyor belt speed. Most prior art systems use a rotary encoder on a pivoting frame incorporated within a steel and rubber dog fitted to another pivoting frame. Said wheel is fitted inside the conveyor apparatus and runs on the upwardly facing inner surface of the conveyor belt. Due to the prevalence of dust and larger particles of hard, and/or friable material in this part of the apparatus, the wheel is prone to slippage, sticking and breaking. Other systems use a rotary encoder on one of the main drums at an end of the conveyor apparatus. These are more reliable, but the data cable has a long way to route through various frames. Moreover such cables often fail.

Regarding the measurement of volume or mass of material on the belt, a number of methodologies are known in the art including measuring the deflection of the conveyor belt, reflectivity of optical light or illumination using a y-ray source. On the speed of the belt itself, then a typical method utilises a dog wheel which engages the upper side of the circulating endless conveyor belt. However, the bearings of the dog wheel are frequently damaged so that friction affects the rotation of the dog wheel which either ceases rotation or jams and so does not properly measure speed.

A typical prior art generic weighing apparatus has steel carry rollers which tend to stick and the internal bearing often collapse if the work environment is abrasive. Additionally dirt and debris will often build up on the steel rollers which increases their size and so affects the accuracy of the weigh module.

It is an object of the present invention to address the above problems and to seek to provide a weigh module which is more durable, less prone to wear and can also be installed/replaced more easily than is currently the case.

### SUMMARY OF THE INVENTION

According to the invention there is a provided a weigh module for a belt conveyor apparatus, said module comprising a plurality of shafts configured to support a conveyor belt;

a means to measure rotation of the shaft;

support means configured to rotatably support the plurality of shafts, wherein the plurality of shafts are parallel;

a load cell configured to determine the load on the conveyor belt, and a load plate engaging with the load cell such that two or more of the plurality of shafts are coupled to the load plate via the load cell.

The provision of a plurality of shafts, rather than a single shaft as disclosed in the prior art provides additional support and built-in redundancy to a weigh module.

Advantageously, the means to measure rotation is an encoder mounted at an end of one of the plurality of shafts which reduces the chance of failure of the measurement means.

Preferably the plurality of shafts are coupled via a drive belt, which is further preferably a “V”-belt. The coupling together of the shafts enables the weigh module to continue functioning in the event of one of the shafts becoming partially jammed towards rotation.

The plurality of shafts are preferably at 90 degrees to the flow of the conveyor belt to maximise the rotational force imparted to the shaft by the conveyor belt.

Advantageously adjacent shafts are at the same height to produce even load bearing on the adjacent shafts.

Preferably a weigh module has two parallel shafts.

Optionally, the load plate spans across and is supported by the two or more shafts, the load cell engaging the upper surface of the load plate.

Conveniently, two or more of the plurality of shafts are mounted on a flange plate, the flange plate arranged, further conveniently, perpendicularly to the two or more shafts. Yet further conveniently one of the two or more of the plurality of shafts rests in a slot in the upper edge of the flange plate, which eases maintenance and replacement of a shaft.

Preferably at least one of the plurality of shafts is cylindrical and yet further preferably at least one of the plurality of shafts comprises a plurality of rings coaxially mounted along the length of the shaft in spaced relationship to each other. The use of rings provides better contact with a conveyor belt and also facilitates repair when required. Yet further preferably, the plurality of rings are formed of a rubber material to provide good frictional engagement with a conveyor belt.

Preferably each one of the plurality of shafts is supported on the flange plate, said flange plate being mounted in a vertical plane, the flange plate being adapted to be secured to a chassis supporting a conveyor belt. Further preferably, the flange plate comprises shelf elements on which the support means rests.

### BRIEF DESCRIPTION OF THE DRAWINGS

The invention is now described with reference to the accompanying drawings which show by way of example only, one embodiment of a weigh module. In the drawings:

FIG. 1a is a perspective view of a weigh module;

FIG. 1b is an expanded view of the region, detail A shown in FIG. 1a;

FIG. 2a is planned view of the module of FIG. 1a;

FIG. 2b is a side view of the module of FIG. 1a;

FIG. 3 is an expanded view of region B of FIG. 2b;

FIG. 4 is an exploded perspective view of the weigh module of FIG. 1a; and

FIG. 5 is an expanded view of region C of FIG. 4.

### DETAILED DESCRIPTION OF THE INVENTION

Continuous conveyor belt weighing devices have been in use within industry for many years. A majority incorporate standard features across the range, which includes the provision of a hinged frame fitted inside the conveyor. The frame has steel rollers with small inboard bearings. In the centre of the moving end of the frame there is a single load cell with a bolt head resting on a fixed tab. Such assemblies require a relatively highly skilled operator to install and the resulting configuration can be unbalanced. Moreover such installations are normally of a fixed width which is limiting in respect of the width of belt from which a measurement can be taken.

For the reasons set out below, the accuracy of prior art devices can vary widely. Firstly, measurements require knowledge of the value of two measurements: the speed of the conveyor belt and the mass on the belt in the region of the mass-measuring element. Both values can be difficult to obtain, even under good operating conditions. However, the airborne dust and large particulates typically found in the working environments in which conveyor belt devices are installed, exacerbate the problems and also increase wear on the device's components.

Typical prior art systems use a single shear beam weigh cell in the centre of the pivoting frame, opposite to the hinged site. For this method to be accurate, material travelling on the conveyor must be evenly spread which is often not possible. Furthermore, to make adjustments to the weigh cell can be difficult.

A further difficultly in prior art apparatus is that a shaft or roller can become difficult to rotate if dust or other debris becomes lodged in the roller's axle. Moreover, prior art weighing devices are difficult to repair and also quite often to install due to the varying dimensions of conveyor belt apparatus.

The present invention seeks to address the above set out deficiencies in the prior art and provides a plurality of shafts having mounted to at least one of said shafts a rotary encoder to determine the speed of a conveyor belt. The module includes weighing means to determine the mass of the conveyor belt and material thereon above the weighing module.

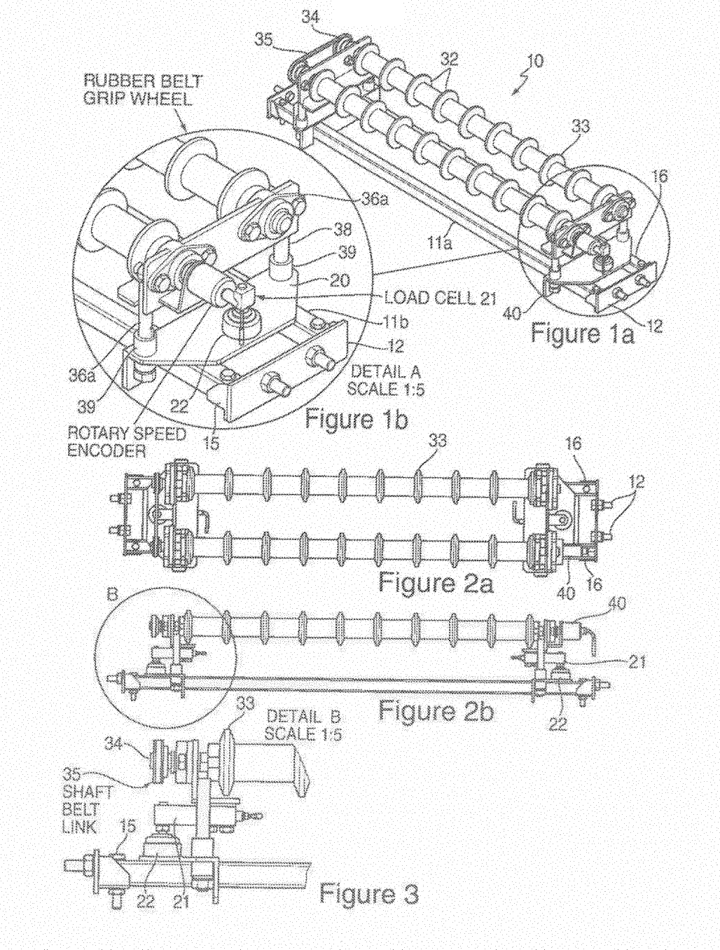

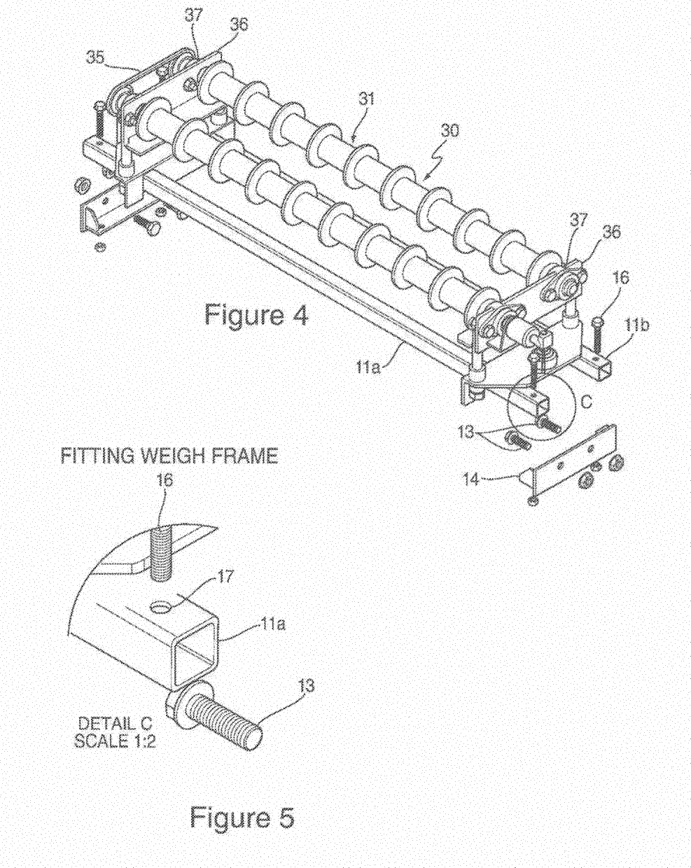

Referring to the figures and initially to FIG. 1a, a weigh module in accordance with the current invention is disclosed. The module, generally referenced 10 is intended to be able to be installed retrospectively into an already in-use apparatus or, where applicable also into new apparatus. The module is fixed such that it spans across a conveyor apparatus and such that the direction of travel of the conveyor is perpendicular to the length of the shafts included in the module. Further, in the exemplified embodiment, the apparatus is illustrated having 2 rotatable shafts to support a conveyor belt. However, apparatus having more than 2 rotatable shafts as part of a weigh module lie within the scope of the invention. An apparatus having 3 or 4 rotatable shafts is also particularly contemplated.

The module 10 has support frame members 11a, 11b formed of a suitable material such as steel. The support frame members 11a, 11b are square tubular and can readily be cut on-site to the desired length enabling the support frame member 11a, 11b to be incorporated within different apparatus. The above enables ready replacement of worn or defective parts in a manner which is far more easily achieved than with conventional weigh modules. The ends of the support frame members 11a, 11b are secured to a flange plate 12. The flange plate 12 can in turn be secured to the chassis of a conveyor belt apparatus, for example by means of studs or bolts 13. A shelf 14 extends from the flange plate 12, the shelf 14 having a side wall 15 to prevent a frame member 11a from falling therefrom when the frame member 11a rests thereon. The frame members 11a, 11b are further secured to the shelf 14 by bolts 16, passing through corresponding holes in the shelf 14 and the frame member 11a respectively.

Secured across the frame members 11a, 11b towards each end to the frame members 11a, 11b is a shear beam weigh cell. The weigh cell comprises a load plate 20 secured across the frame members 11a, 11b. Resting on the surface of the load plate 20 is a load cell 21 which measures the mass of the material on the conveyor of the conveyor apparatus, directly above the weigh cell. The load cell 21 contacts the load plate 20 through a hard rubber foot 22 and spherical bearings. The spherical bearings are internal to the rubber foot 22 and allow adjustment of the foot. The use of the rubber material for the foot 22 provides a uniform grip across the length of the shaft and also reduces vibration within the apparatus which results in a reduction in the noise generation and wear on the components. The load cell 21 is mounted centrally between the shafts 30 to ensure that the measurement is not biased towards either shaft 30 and is approximately along the plane of their centre of gravity. This also reduces the effects of vibration and allows measurements to the accurately made, even at high speeds. In an embodiment of the apparatus, not illustrated, the shafts can be at different heights to each other, which enables the apparatus to be easily mounted on an uneven or sloping surface. The angle then described by the belt with the horizontal can be from 10° to 30°, although 20°-25° is convenient. The load cell operates most effectively when the sensor of the load cell is perpendicular to the floor. Care should be taken therefore, that the sensor is maintained at the correct angle, irrespective of the angle of the belt.

Information from the weigh cell is transmitted in either digital or analogue form to the systems programmable logic controller (PLC). The use of load cells 21 at both ends of the module 10 allows measurements to be made, even where the load is distributed unevenly on the conveyor belt. Moreover, additional load cells 21 can be incorporated into an apparatus to further improve accuracy and also potentially reduce downtime of the apparatus. An apparatus having 3, 4 or more load cells can be contemplated. For example, where 4 load cells are utilised then an arrangement in which the load cells operate in pairs, with a pair on each side of the belt, is preferred. Additionally, two or more load cells can be linked together such that the output from said load cells is combined to provide an average value for the mass of the material. The averaging operation can be carried out by means of software controlling the module.

Turning to the rotatable shafts 30, the exemplified embodiment comprises two shafts which are mounted with parallel, horizontally aligned axes. Typically the shafts are at the same height to more evenly support a conveyor belt and provide a more accurate measurement of the mass of material on the conveyor belt. However, when required, the shafts can be mounted such that they are offset relative to each other in the vertical direction. A conventional apparatus relies on a single shaft which results in standing waves and vibrations being set up along the belt, which can affect measurement.

Each shaft 30 comprises an inner cylindrical portion 31. Arrayed along the length of the cylindrical portion 31 are belt-grip wheels 32, which engage the underside of the conveyor belt. The belt-grip wheels 32 are formed of a material having, at least in respect of the wheel surface 33 of the wheel engaging the belt, a high co-efficient of friction. A rubber material, and especially a hardened rubber material is suitable for said surface 33. The frictional engagement of the wheels 32 with the conveyor belt causes the shaft 30 to rotate as the conveyor belt moves, and said rotation of the shaft is then utilised in the determination of the speed of travel of the conveyor belt. The rubber material of the belt grip wheels 32 dampen the vibrations generated by the movement of the conveyor over shaft 30/wheels 32.

It is important therefore that the shaft 30 remain in good engagement with the conveyor belt as any slippage, due to poor contact between the shaft 30 and the conveyor belt will result in a false reading. The use of the wheels 32 about the shaft 30 assists in this engagement in comparison to prior art shafts which primarily are simply cylindrical in shape. The wheels 32 ensure that contact between the wheels surface 33 and the conveyor belt is concentrated in a smaller region so that the weight of the conveyor belt and the load is concentrated in said smaller region, thus enhancing the frictional force between the shaft overall and the conveyor belt. The risk of slippage between the shaft and the conveyor belt is thereby reduced.

To reduce the chance of one of the shafts jamming, not rotating freely, the two shafts 30 are coupled together for rotational motion. Extending from each of the shafts 30 is a belt mount 34. A belt 35, typically an endless “V”-belt is mounted about each of the mounts 34 so connecting the shafts 30 for rotation. The belt mounts 34 optionally each have a channel (not illustrated) in which the belt 35 is located. In the event that one of the shafts 30 jams therefore or does not rotate freely due to dust or other particulate contaminant accumulating in the mounts, rotation of the other shaft 30 is conveyed to the jammed shaft via the belt 35 and mounts 34 which acts to force the jammed shaft into rotational motion, removing at the same time the blockage. The measurements are thus enabled to continue without having to stop the entire apparatus.

Each of the shafts 30 is mounted to a further flange plate 36 at either end of the shaft 30. To facilitate the rotation, each shaft 30 is located within a flange slot 37. In the event of a shaft 30 requiring replacement or repair work therefore, the shaft 30 can simply be lifted out of the slot 37 and a new shaft 30 inserted. Mounts 36a secure the shaft to the flange plate 36 and resist axial movement of the shaft. In a further embodiment, not illustrated, each shaft is mounted to a separate flange plate enabling a flange plate/shaft assembly to be removed for maintenance. It will be appreciated that when a shaft is removed temporarily, the conveyor can then continue to run, albeit sub-optimally, and perhaps without measurements being taken, using only a single shaft. There is then a reduced loss of conveyance of material. In a yet further embodiment a shaft is supported on outboard bearings which are more easily maintained in a clean condition and so less likely to breakdown.

The further flange plate 36 is itself supported on legs 38 located inside locating elements 39, secured to and mounted on the load plate 20. The legs 38 are able to move in the vertical direction by 1-2 mm and thus enabling the vertical movement of the flange plate 36 relative to the load plate 20, thereby adjusting the position of the shafts 30.

In order to determine the speed of rotation of the shaft 30 a reading is preferably made directly from the shaft. A rotary encoder 40 is attached to one end of the one of the shafts 30. The exemplified encoder is an incremental encoder that transmits the speed of rotation of the shaft back to the PLC. An encoder 40, being located on the end of the shaft 30 is easy to access for maintenance and is also not exposed to a hazardous environment as in the prior art wheel and is hence more reliable. The encoder 40 can be located on the leading or trailing shaft 30 in relation to the movement of the conveyor.

Optionally, means to determine whether the conveyor belt is running off line can be included. Such lateral movement can be damaging to the apparatus and so its early detection is useful. To this end, a photoelectric sensor can be fitted to the outside edge of the weigh module, for example on a frame member, and optionally facing downwards and on to the return side of the belt, which determines the extent of lateral movement of the belt. A linkage communicating the information concerning the belt to the PLC, enables a warning message to be sent to a user, which message can comprise a warning light on the HMI.

The PLC is programmed to encrypt the incoming digital data from the shear beam load cells and the rotary encoder and converter and recorder of actual weight. The data can be accessed via a Human-Machine Interface (HMI) interface panel. Data can also be accessed by a built in modem via the telephone network.

In use therefore, to install a weigh module into a conveyor apparatus, the support frame members are cut to length to sit within the conveyor belt apparatus chassis beneath the conveyor belts. The frame members are then mounted by means of the flange plates 12 to the chassis. The shaft 30 and flange plate 36 assembly can be pre-prepared and the legs 38 located and secured in the locating elements 39. Once the encoder and load cell are connected to the PLC, the module is ready for use. The more rapid installation time for the module results in less downtime for the apparatus.

It will be understood that the invention is not limited to the specific details described herein, which are given by way of example only, and that various modifications alterations are possible within the scope of the appended claims.

1. A weigh module for a belt conveyor apparatus, said module comprising:
a plurality of shafts configured to support a conveyor belt;
a means to measure rotation of the shaft;
a support means configured to rotatably support the plurality of shafts, wherein the plurality of shafts are parallel;
a load cell configured to determine the load on the conveyor belt; and
a load plate engaging with the load cell such that two or more of the plurality of shafts are coupled to the load plate via the load cell.

2. A weigh module according to claim 1, wherein the means to measure rotation is an encoder mounted at an end of one of the plurality of shafts.

3. A weigh module according to claim 1, wherein the plurality of shafts are coupled via a drive belt.

4. A weigh module according to claim 3, wherein the drive belt is a “V”-belt.

5. A weigh module according to claim 1, wherein the plurality of shafts are at 90 degrees to the flow of the conveyor belt.

6. A weigh module according to claim 1, wherein adjacent shafts are at the same height to produce even load bearing on the adjacent shafts.

7. A weigh module according to claim 1, wherein a weigh module has two parallel shafts.

8. A weigh module according to claim 1, wherein the load plate spans across and is supported by the two or more shafts, the load cell engaging the upper surface of the load plate.

9. A weigh module according to claim 1, wherein two or more of the plurality of shafts are mounted on a flange plate.

10. A weigh module according to claim 1, wherein the flange plate is arranged perpendicularly to the two or more shafts.

11. A weigh module according to claim 1, wherein one of the two or more of the plurality of shafts rests in a slot in the upper edge of the flange plate.

12. A weigh module according to claim 1, wherein at least one of the plurality of shafts is cylindrical.

13. A weigh module according to claim 12, wherein the at least one of the plurality of shafts includes a plurality of rings coaxially mounted along the length of the shaft in spaced relationship to each other.

14. A weigh module according to claim 13, wherein the plurality of rings are formed of a rubber material.

15. A weigh module according to claim 9, wherein each one of the plurality of shafts is supported on the flange plate, said flange plate being mounted in a vertical plane, the flange plate being adapted to be secured to a chassis supporting a conveyor belt.

16. A weigh module according to claim 15, wherein the flange plate comprises shelf elements on which the support means rests.

17. (canceled)
